(19) United States
(12) Patent Application Publication
(10) Pub. No.: US 2025/0356265 A1
(43) Pub. Date: Nov. 20, 2025

(54) METHOD AND SYSTEM TO PREDICT HAZARDS FOR PROJECT ACTIVITIES

(71) Applicant: SAUDI ARABIAN OIL COMPANY, Dhahran (SA)

(72) Inventors: Syed Ali Raza, Dhahran (SA); Abdulellah Hatem Abualshour, Dhahran (SA); Ali Mohammed Abusnina, Dhahran (SA)

(73) Assignee: SAUDI ARABIAN OIL COMPANY, Dhahran (SA)

(21) Appl. No.: 18/664,490

(22) Filed: May 15, 2024

(51) Int. Cl. G06N 20/20; G06N 3/096

(52) U.S. Cl. CPC G06N 20/20; G06N 3/096

(57) ABSTRACT

A method for determining a predicted hazard, an impact area, a mitigation action and a risk assessment score for an activity. The method includes obtaining a future activity and predicting, using a first machine-learned model, a predicted hazard for the future activity. The method further includes predicting, using the predicted hazard and a second machine-learned model, an impact area for with the predicted hazard. The method further includes determining, using the predicted hazard, the historical safety data and a natural language processing algorithm, a mitigation action for the predicted hazard and a risk assessment score for the predicted hazard; and planning the project using the predicted hazard, the impact area, the mitigation action and the risk assessment score.

### BACKGROUND

Projects, such as construction projects, comprise numerous activities, where each activity has its own associated safety hazard(s). Traditional methods of identifying safety hazards and assessing risk exposures associated with projects and their activities often rely on manual analysis and human judgment, which may be time consuming and costly. There is a need for a method to better identify safety hazards and assess risk exposures so as to mitigate accidents in a work environment.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method. The method includes obtaining a future activity. The future activity is associated with a project planned for a future time. The method also includes predicting, using a first machine-learned model, a predicted hazard for the future activity, wherein the first machine-learned model has been trained using a first subset of historical safety data to predict at least one hazard for an input activity. The historical safety data is associated with a plurality of activities. The method further includes predicting, using the predicted hazard and a second machine-learned model, an impact area for with the predicted hazard. The second machine-learned model was trained on a second subset of the historical safety data and a set of impact areas classes. The method further includes determining, using the predicted hazard, the historical safety data and a natural language processing algorithm, a mitigation action for the predicted hazard and a risk assessment score for the predicted hazard; and planning the project using the predicted hazard, the impact area, the mitigation action and the risk assessment score.

In one aspect, embodiments disclosed herein relate to a system. The system includes a first machine-learned model, a second machine-learned model, and a computer. The computer is configured to obtain a future activity. The future activity is associated with a project planned in for a future time. The computer is also configured to predict, using the first machine-learned model, a predicted hazard for the future activity, wherein the first machine-learned model has been trained using a first subset of historical safety data to predict at least one hazard for an input activity. The historical safety data is associated with a plurality of activities. The computer is further configured to predict, using the predicted hazard and the second machine-learned model, an impact area for the predicted hazard. The second machine-learned model has been trained on a second subset of the historical safety data and a set of impact areas classes. The computer is further configured to determine, using the predicted hazard, the historical safety data and a natural language processing algorithm, a mitigation action and a risk assessment score for the predicted hazard; and plan the project using the predicted hazard, the impact area, the mitigation action and the risk assessment score.

In one aspect, embodiments disclosed herein relate to a non-transitory machine-readable medium including a plurality of machine-readable instructions executed by one or more processors. The plurality of machine-readable instructions cause the one or more processors to perform a method. The method includes obtaining a future activity. The future activity is associated with a project planned for a future time. The method also includes predicting, using a first machine-learned model, a predicted hazard for the future activity, wherein the first machine-learned model has been trained using a first subset of historical safety data to predict at least one hazard for an input activity. The historical safety data is associated with a plurality of activities. The method further includes predicting, using the predicted hazard and a second machine-learned model, an impact area for with the predicted hazard. The second machine-learned model was trained on a second subset of the historical safety data and a set of impact areas classes. The method further includes determining, using the predicted hazard, the historical safety data and a natural language processing algorithm, a mitigation action for the predicted hazard and a risk assessment score for the predicted hazard; and planning the project using the predicted hazard, the impact area, the mitigation action and the risk assessment score.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts a schematic diagram of a construction project in accordance with one or more embodiments.

FIG. 2 depicts a high-level overview of a process in accordance with one or more embodiments.

FIG. 3 depicts an overview of a process in accordance with one or more embodiments.

FIG. 4 depicts a simplified random forest classifier in accordance with one or more embodiments.

FIG. 5 depicts a neural network in accordance with one or more embodiments.

FIG. 6 depicts a flowchart in accordance with one or more embodiments.

FIG. 7 depicts a flowchart in accordance with one or more embodiments.

FIG. 8 depicts a system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to a “hazard” can include reference to one or more of such hazards.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in a flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

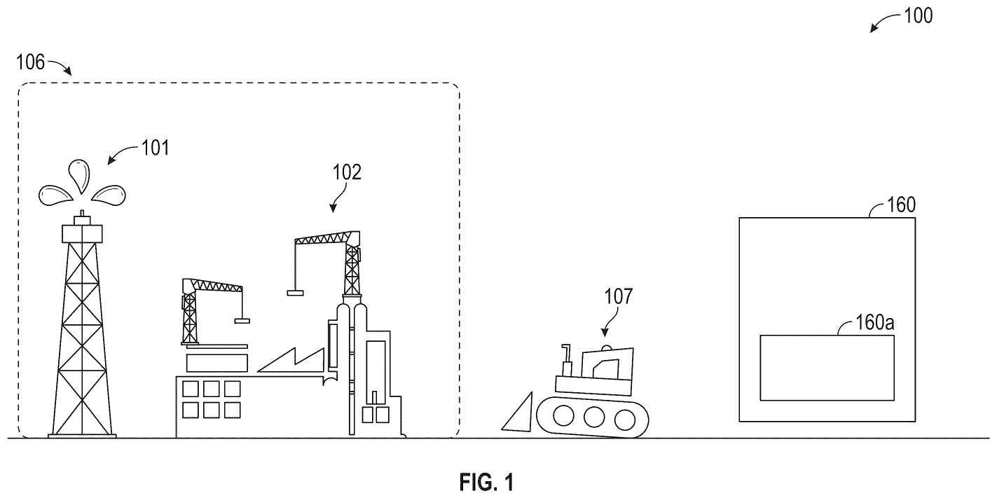

In the following description of FIGS. 1-8, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Projects, such as construction projects, comprise numerous activities, where each activity has its own associated safety hazard(s). In general, embodiments disclosed herein relate to methods and systems to better identify safety hazards and assess risk exposures so as to mitigate accidents in a work environment. Specifically, embodiments disclosed herein describe a system and method to predict the hazards linked with planned activities in projects, particularly construction projects, with regard to their associated likelihoods, severities, and potential impact area. The system utilizes several data sources including job safety analysis documents, historical incident reports, as well as safety policies, guidelines, and risk registers. In one or more embodiments, the system also recommends safety control measures and mitigation actions based on the associated hazards in order to assist safety subject matter experts in reducing risk, incident likelihood, and potential severity.

FIG. 1 shows a schematic diagram of a construction project in accordance with one or more embodiments. However, one with ordinary skill in the art will recognize that that the present disclosure can be applied to other projects where safety is of concern, such as operations using chemicals (e.g., a chemical plant, power plant, or any other plant), electrical projects, etc.

As shown in FIG. 1, a construction site (100) includes a facility (106) under construction, a team of workers (107) tasked with undertaking an activity, and a construction planning system (160) comprising a hazard prediction engine (160a). In particular, the construction of the facility (106) is referred to as the construction project while the location undergoes the construction project is referred to as the construction site. For example, the construction site (100) and the construction planning system (160) may relate to constructing a rig (101) in the oil and gas industry. In other examples, the construction site (100) and the construction planning system (160) may equally apply to other types of construction project (e.g., pipeline, processing plant) in the oil and gas industry and/or any other industries, such as manufacturing, energy (e.g., nuclear, solar, wind, hydropower), chemical, infrastructure (bridges, highways, buildings), transportation (automotive, railways), maritime, building construction, aerospace, etc.

In the example shown in FIG. 1, the facility (106) (e.g., rig (101), building (102)) is planned to be constructed and/or installed by a team of workers (107) such as employees of an oversight entity (e.g., an oil and gas company) of the construction project or workers managed by a third-party contractor hired by the oversight entity.

In one or more embodiments, the construction planning system (160) includes hardware and/or software with functionality for facilitating the planning of various aspects of constructing the facility (106). For example, the construction planning system (160) may continuously and proactively schedule a set of activities required for the construction of the facility (106), assign a team of workers (107) to each activity, alter the required personnel for each team of workers (107) to meet scheduling requirements and deadlines, and schedule equipment and resources to be used for each activity.

In addition, the construction planning system (160) may automatically assess hazards associated with planned future activities using the hazard prediction engine (160a). In FIG. 1, the hazard prediction engine (160a) is illustrated as being part of the construction planning system (160). One skilled in the art will recognize that alternatively the hazard prediction engine (160a) may be separate to, but in communication with, the construction planning system (160).

The hazard prediction engine (160a) may predict hazards that have a possibility of occurring during undertaking of an activity, the impact of such a hazard occurring, such as an area of the construction site or construction plan that may be impacted, the likelihood of the hazard occurring and the likely severity of the hazard should it occur. The hazard prediction engine (160a) may automatically suggest control measures (or mitigation actions) to mitigate the risks associated with the activities.

In one or more embodiments, the outputs of the hazard prediction engine (160a) are used by the construction planning system (160) to reduce risk. For example, the construction planning system may reschedule, add, remove or alter planned activities, and adjust personnel and equipment requirements. Accordingly, high safety behaviors are enforced to guard personnel and assets.

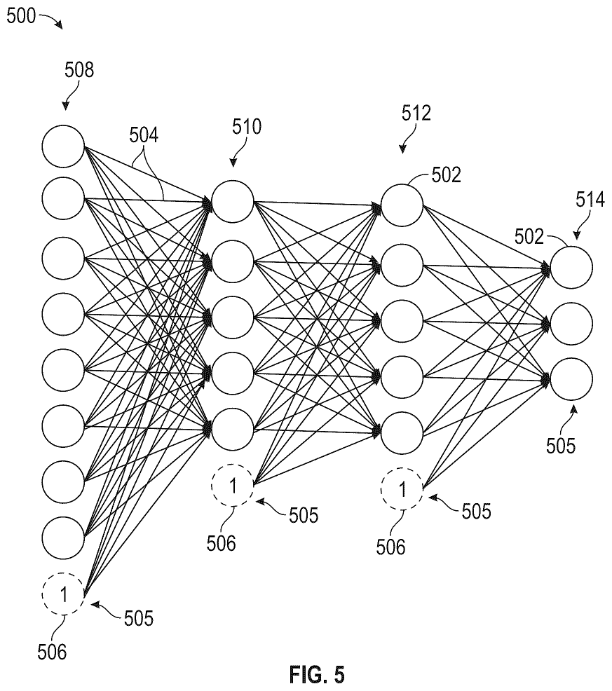

In one or more embodiments, the hazard prediction engine (160a) utilizes machine learning (ML) techniques to predict hazards associated with activities. Such ML techniques are discussed in further detail below and an example neural network is shown in FIG. 5.

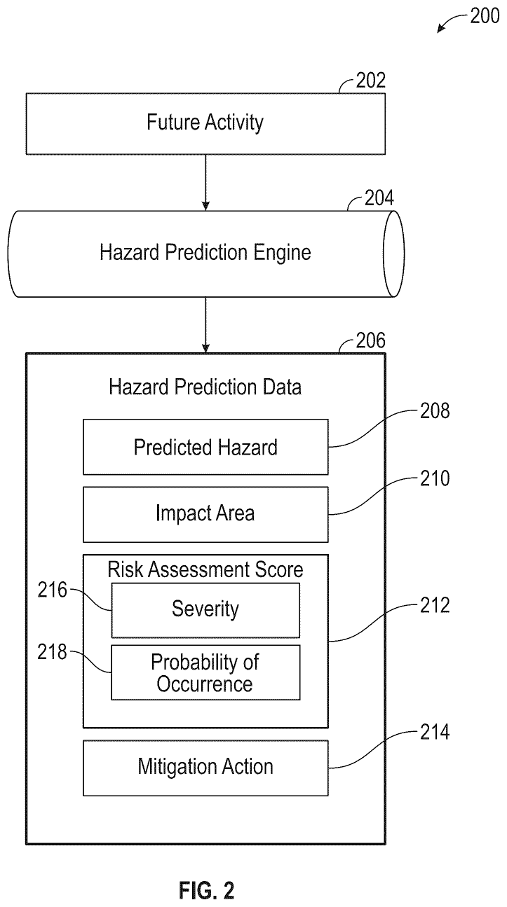

FIG. 2 depicts a high-level overview (200) of the process carried out by the hazard prediction engine (160a) according to embodiments disclosed herein. First, a future activity (202) of the construction project is acquired from the construction planning system (160). The future activity (202) is an activity that has not been carried out but is scheduled to be undertaken and completed at a time in the future. Examples of the future activity (202) include welding, cladding external walls, electrical system installation etc. According to one or more embodiments, the future activity (202) has been identified by the construction planning system (160) of FIG. 1.

The future activity (202) is processed by a hazard prediction engine (204). The hazard prediction engine (204) comprises machine-learned models and natural language processing (NLP) algorithms. The machine-learned models and NPL algorithms will be described in greater detail later in the instant disclosure. However, for now, it is stated that the hazard prediction engine (204) is configured to receive the future activity (202) and, upon processing, output hazard prediction data (206). The hazard prediction data (206) may include a predicted hazard (208), an impact area (210) of the predicted hazard, a risk assessment score (212), and a mitigation action (214).

The predicted hazard (208) identifies a hazard that may occur as a result of undertaking the future activity (202). As an activity can be associated with more than one hazard, the predicted hazard (208) may identify a plurality of hazards that may occur as a result of undertaking the future activity (202). The predicted hazard (208) may be a name indicating the hazard. In an example where the future activity (202) is welding, a predicted hazard (208) may be the text string “hot surface”. Alternatively, the predicted hazard could be a number or other indicator that indicates that the predicted hazard is the hot surface.

The impact area (210) identifies an area of the project, or a resource, that will be affected should a hazard occur. The impact area (210) may identify a plurality of areas that could be affected should a hazard occur. In an example where the predicted hazard (208) is “hot surface”, an impact area (210) may be people. Alternatively, in an example where the predicted hazard (208) is “fire”, an impact area (210) may be people, equipment, premises, or the next phase of the planned project.

The risk assessment score (212) may include a severity (216) of the risk exposure, and/or a probability of occurrence (218) of the hazard. Severity (216) of the risk exposure is measure of the seriousness of the consequences of a hazard should it occurs. The severity (216) may be determined as a numerical value. The severity (216) may alternatively be another indicator such as a text string indicating “Minor” or “Catastrophic”, a color of a color scale representing the severity, etc. The probability of occurrence (218) of a hazard is the likelihood that the predicted hazard (208) may occur. The probability of occurrence (218) may be a number, such as a percentage, or another indicator indicating the probability of occurrence such as “Highly likely” or “Not likely”.

According to one or more embodiments, the risk assessment score (212) may be a numerical value, text string or indicator that is a combination of both the severity (216) and the probability of occurrence (218). For example, if both the severity (216) and the probability of occurrence (218) are numerical values, the risk assessment score (212) may be a function of both.

The mitigation action (214) is a recommended action that if implemented would reduce the probability of occurrence (218) and the severity (216) of the predicted hazard (208) should it occur. The mitigation action (214) may be a numerical value, text string or indicator. For example, in the case where the predicted hazard (208) is “hot surface”, the mitigation actions may be a text string indicating “Use proper hand gloves”. Alternatively, the mitigation action (214) may be number, symbol or other indicator that indicated to use proper hand gloves.

The hazard prediction data (206) may then be displayed to a user or provided to the construction planning system (160) to reduce risk associated with the activity, and hence the project.

TABLE 1 below illustrates an example output of the hazard prediction engine (204) where the future activity (202) is welding.

TABLE 1

| Predicted | | |
|---|---|---|
| Hazard | Mitigation Action | Other |
| 1. Contact with | Coating personnel should | Severity: Insignificant |
| skin and eyes | wear disposable coverall. | Prob. of occurrence: Very high |
| skin and eye | Wear appropriate gloves | Impact Area: People |
| irritation | and eye protection. | |
| | Working shall not be | |
| | permitted on steel or other | |
| | surfaces. | |
| | paint/coating is still wet. | |
| 2. Exposure to | Ensure that periodic | Severity: Insignificant |
| excessive dust | maintenance of all heavy | Prob. of occurrence: High |
| | equipment vehicles is | Impact Area: People |
| | applied and recorded. | |
| | Visual inspection of | |
| | hydraulic system shall be | |
| | done by driver and | |
| | flagman/spotter. | |
| 3. Eye bodily | There are no controls for | Severity: Insignificant |
| injury | this Hazard | Prob. of occurrence: Very low |
| | | Impact Area: People |
| 4. Hot surface | Do not touch hot surface | Severity: Minor |
| | with naked hands. | Prob. of occurrence: High |
| | Use proper hand gloves. | Impact Area: People |
| 5. injury and | De energized all exposed | Severity: Catastrophic |
| electrocution | electrical cord, extension | Prob. of occurrence: High |
| | or cable during rain.; | Impact Area: People |
| | Immediately stop all | |
| | outdoor involved in | |
| | electrical activity during | |
| | light/heavy rain.; Check | |
| | all electrical tools/ | |
| | equipment after the rain | |
| | and ensure that is not wet | |
| | prior to use.; Use GFCI | |
| | outlet or ELCB | |
| | connection. | |
| | All electrical extension | |
| | cables and power | |
| | tools/hand tools are in | |
| | good condition and | |
| | inspected by competent | |
| | person prior to use. | |

In traditional risk assessments, these predicted hazard data (206) are often subjectively estimated by safety experts, based on commonly agreed evaluation criteria. However, in the present invention, these variables are determined using a trained ML model and NPL algorithms, as will be described in greater detail later. Hence, embodiments disclosed herein enable a significant advancement in the application of risk assessment and mitigation, leveraging data-driven approaches for more objective and potentially accurate risk assessments and prevention of major hazards.

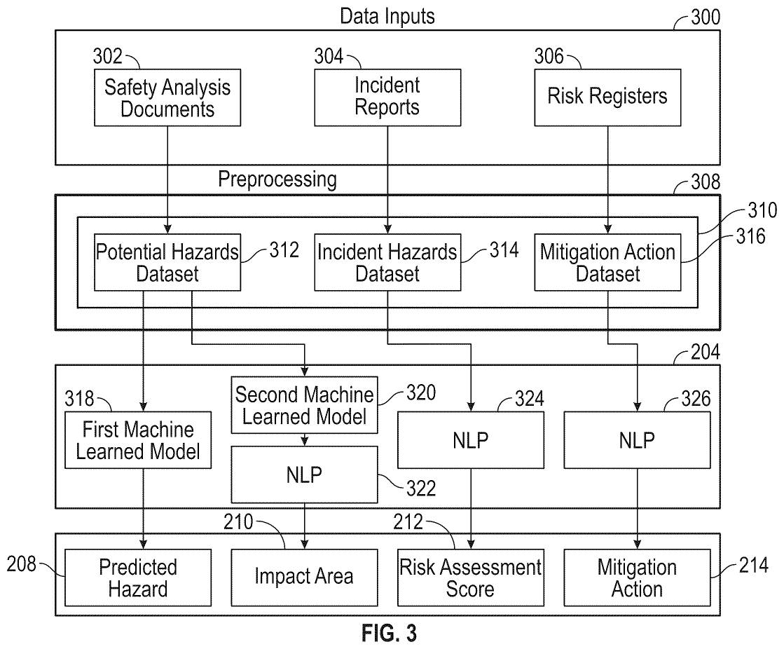

In accordance with one or more embodiments, FIG. 3 depicts a flow diagram which describes the process of developing and using the hazard prediction engine (204) to determine the predicted hazard data (206).

In FIG. 3, data inputs (300) are obtained from a plurality of sources. In accordance with one or more embodiments, the plurality of sources may comprise a plurality of internal and/or external databases. In accordance with one or more embodiments, the data inputs (300) may include historical safety analysis documents (302), historical incident reports (304), and historical risk registers (306). For example, historical safety analysis documents (302) may be risk assessment documents which have been historically prepared by risk assessors (safety experts) to identify hazards and risks associated with different activities prior to the activities being carried out. Incident reports (304) may include detailed accounts of previous incidents (or hazards) that have occurred as part of a project when an activity was being carried out. The incident reports (304) may include details of the hazard, such as its severity and impact. Further, historical risk registers (306) are registers that have been prepared by risk assessors when assessing the risk or hazards that may occur when undertaking an activity. The historical risk register (306) includes information relevant to a hazard associated with an activity, along with mitigation actions that can be implemented to reduce the risk of the hazard, quantitative risk assessments, safety regulations and standards. Risk registers (306) may be embedded within the historical safety analysis documents (302), or they may be separate documents.

One skilled in the art will recognize that additional or alternative data sources may be used including safety policies, equipment or material datasheets, or activity/project guidelines.

According to one or more embodiments, the data inputs (300) are preprocessed to obtain preprocessed data (308) to be received by the hazard prediction engine (204). Generally, and as will be described later in the instant disclosure, preprocessing comprises, at a minimum, altering the data inputs (300) so that they are suitable for use with the hazard prediction engine (204).

According to one or more embodiments, the pre-processing may comprise selecting subsections of data from the data inputs (300) or creating datasets from the data inputs (300).

In an embodiment the pre-processing involves generating at least one database (310). The database (310) may comprise a plurality of datasets as illustrated in FIG. 3, including a potential hazards dataset (312), an incident hazards dataset (314) and a mitigation action dataset (316). Alternatively, the datasets may all be comprised within a single dataset.

The potential hazards dataset (312) is a multi-label dataset that provides a mapping of activities to potential hazards, i.e. hazards that may occur as a result of undertaking the activity. According to one or more embodiments, to generate the potential hazards dataset (312), all the historical safety analysis documents (302) are labeled with input labels and target labels. For each safety analysis document (302), each activity detailed within the safety analysis document (302) is an input label and each hazard identified in the safety analysis document (302) as being associated with the activity is a target label. Therefore, for each safety analysis document (302) there may be multiple input labels, with each input label having multiple target labels. According to one or more embodiments, the input and target labels are assigned manually by a safety expert. Alternatively, the input and target labels may be assigned by using an NLP algorithm to extract the labels from each safety analysis document (302). According to one or more embodiments, a machine-learned model may be used as an auto-labeler for new inputs. According to one or more embodiments, a machine-learned model comprised in hazard prediction engine (204) may be trained on the manually labeled data set to determine a predicted hazard for a future activity. This machine-learned model, once trained, may then also be used as an auto-labeler for new inputs.

From the input and target labels, a dataset of activity-to-hazard mappings is generated. An example of entries in the potential hazard dataset (312) is:
a. Activity 1 description
   i. Hazard A
   ii. Hazard B
   iii. Hazard C
b. Activity 2 description
   i. Hazard D
   ii. Hazard E

For example, a safety analysis document (302) may specify welding as an activity, and its associated hazards may be specified as “hot surface” and “eye bodily injury”. In this case, the activity “welding” will be assigned an input label, and the hazards “hot surface” and “eye bodily injury” will each be assigned a target label.

The incident hazards dataset (314) maps details of historical activities performed in the past with a hazard that was caused by the respective activity. According to one or more embodiments, the incident hazards dataset (314) is generated from incident reports (304).

According to one or more embodiments, the incident hazards dataset (314) is automatically generated using an NLP algorithm configured to extract activities and hazards from the incident reports (304). According to one or more embodiments, the NLP algorithm is an extractive question and answering pipeline (Q&A). For example, the following natural language questions may be used to extract data from an incident report (304):
a. What was the exact activity being carried out?
b. What was the consequence of said activity?

By extracting this information, a dataset relating incident historical activities against the hazards that were caused by those historical activities. An example entry in the incident hazards dataset (314) is:
a. Incident report description
   i. Activity extracted
   ii. Hazard/consequence extracted

For example, an incident report (304) may specify a welding activity as causing eye bodily injury.

The mitigation action dataset (316) is a dataset that maps hazards to mitigation actions. According to one or more embodiments, the mitigation action dataset (316) is generated from risk registers (306). The risk registers (306) are processed to extract hazards and their associated mitigation actions so as to map activities and hazards to mitigation actions, as detailed below.

According to one or more embodiments, the mitigation action dataset (316) is automatically generated using an NLP algorithm configured to map activities and hazards to mitigation actions/control measures. According to one or more embodiments, the NLP algorithm is a semantic search. The semantic search can also standardize and normalize the types of activities, such as removing duplicates, grouping similar activities, within the risk registers in order to be able to correctly map activities and hazards to mitigation actions/control measures.

According to one or more embodiments, manual labelling by a safety expert may also be performed on the risk registers (306) to facilitate generation of the mitigation action dataset (316).

An example of entries in the mitigation action dataset (316) is:
1. Activity 1 description
   a. Hazard A
      i. Mitigation Action X
      ii. Mitigation Action Y
   b. Hazard B
      i. Mitigation Action X
   c. Hazard C
      i. Mitigation Action X
      ii. Mitigation Action Y
      iii. Mitigation Action Z

For example, where the activity is welding, the mitigation action dataset (316) may identify the hazard “hot surface” and the mitigation action “Use proper hand gloves” (see TABLE 1).

According to one or more embodiments, the pre-processing may further include text manipulation and standardization techniques including tokenization, stemming, lemmatization, applied to the data inputs (300) or the generated database (310) or datasets (312, 314, 316).

The datasets (312, 314, 316) in database (310) are then provided to the hazard prediction engine (204).

The hazard prediction engine (204) comprises a first machine-learned model (318), a second machine learned model (320), and at least one NLP algorithm (322,324).

Before detailing the first machine-learned model (318) and the second machine learned model (320), a cursory introduction to machine-learned models and the general principles related to training such models are provided herein. However, while descriptions of machine-learned models are provided to aid in understanding, one with ordinary skill in the art will recognize that these descriptions do not impose a limitation on the instant disclosure. This is because one with ordinary skill in the art will appreciate that, due to the depth and breadth of the field, a detailed description of the field of machine learning, and the various model types encompassed by the field, cannot be adequately summarized in the present disclosure.

Machine learning (ML), broadly defined, is the extraction of patterns and insights from data. The phrases “artificial intelligence”, “machine learning”, “deep learning”, and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term machine learning (ML), or machine-learned, will be adopted herein, however, one skilled in the art will recognize that the concepts and methods detailed hereafter are not limited by this choice of nomenclature.

Machine-learned model types may include, but are not limited to, k-means, k-nearest neighbors, neural networks, logistic regression, random forests, generalized linear models, and Bayesian regression. Also, machine-learning encompasses model types that may further be categorized as “supervised”, “unsupervised”, “semi-supervised”, or “reinforcement” models. One with ordinary skill in the art will appreciate that additional or alternate machine-learned model categorizations may be defined without departing form the scope of this disclosure. Machine-learned model types are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. Commonly, in the literature, the selection of hyperparameters surrounding a model is referred to as selecting the model “architecture.” Once a machine-learned model type and hyperparameters have been selected, the machine-learned model is trained to perform a task, the performance of the machine-learned model is then evaluated, and the machine-learned model is used in a production setting (also known as deployment of the machine-learned model).

In accordance with one or more embodiments, the selected first machine-learned model (318) type is a random forest classifier, which may operate as a supervised machine learning algorithm performing a classification to predict a hazard associated with an activity scheduled to be carried out in the future. As detailed below, the architecture of a random forest model is suitable for predicting the hazards associated with an activity because it is capable of capturing complex and non-linear relationships between predictors and a target variable.

A random forest model is an ensemble machine learning algorithm that uses multiple decision trees to make predictions. The architecture of random forest models is unique in that it combines multiple decision trees to reduce the risk of overfitting and improve the overall generalization of the model and the accuracy of predictions, in comparison to individual trees. This is based on the idea that multiple “weak learners” can combine to create a “strong learner.” Each individual classifier is considered a “weak learner,” while the group of classifiers functioning together is regarded as a “strong learner.” This approach allows random forests to effectively capture complex relationships and interactions between features, resulting in better predictive performance.

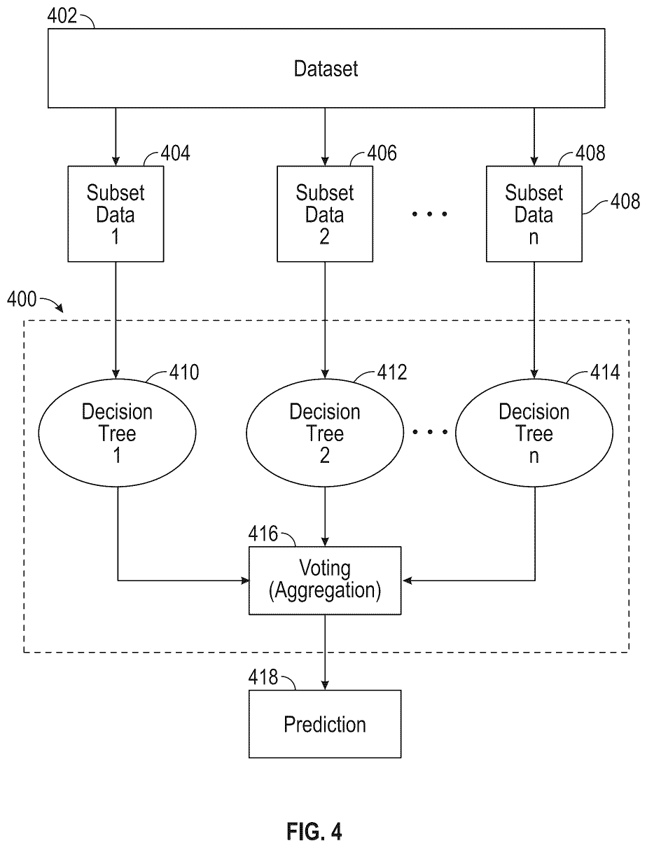

FIG. 4 illustrates a simplified random forest classifier (400) comprising n decision trees (410, 412, 414). Each of the multiple decision trees (410, 412, 414) operates on a different subset (404, 406, 408) of the same dataset (402), followed by taking an aggregate (416) of the results to improve the overall accuracy of the prediction (418). In other words, instead of relying on a single decision tree, the random forest gathers predictions from each tree and makes a final prediction based on the majority of these predictions.

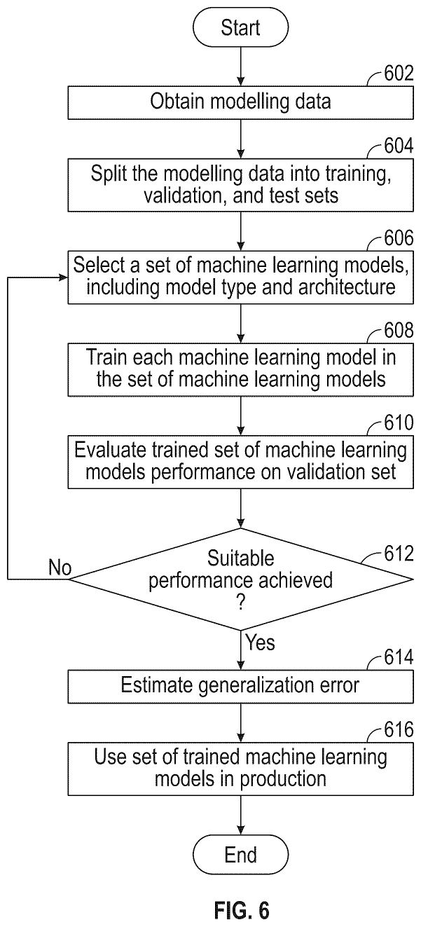

According to one or more embodiments, the first machine learned model (318) is trained using data from the potential hazards dataset (312). In particular, the potential hazards dataset (312) may be split into a training set and a validation set. The training set may be used to train the first machine-learned model (318) to predict (or infer) a hazard for an activity scheduled to be carried out in the future (such as the future activity (202) of FIG. 2). Further details of training machine-learned models are provided below in relation to FIG. 6.

In accordance with one or more embodiments, the selected second machine-learned model (320) type is a zero-shot classification model, used to determine an impact area for a particular hazard. In zero-shot text classification, the model leverages its understanding of language and context, gained through training on large, diverse datasets, to recognize new categories that were not included in the training dataset. This is achieved through a combination of advanced techniques such as transfer learning, where knowledge gained in one task is applied to different but related tasks and sophisticated language understanding.

A zero-shot classifier may be provided with data and a class as input data. In the present application, the second machine learning model (320) may be provided with data from the potential hazards dataset (312) and a set of impact area classes, such as “people”, “equipment” The zero-shot classifier then determines whether each entry in the potential hazards dataset is closer to the impact area “people” or “equipment”. In this way the zero-shot classifier can generate an impact area dataset mapping activities to impact areas.

In this way, the zero-shot classifier can classify classes not seen during training using the knowledge learned from classes seen during training. A zero-shot classifier may be implement using neural networks (NN), convolutional neural networks (CNN) or transformer models. Both CNNs and transformer models can be more readily understood as a specialized neural network (NN). Thus, a cursory introduction to a NN is provided herein.

A diagram of a neural network is shown in FIG. 5. At a high level, a neural network (500) may be graphically depicted as being composed of nodes (502), where here any circle represents a node, and edges (504), shown here as directed lines. The nodes (502) may be grouped to form layers (505). FIG. 5 displays four layers (508, 510, 512, 514) of nodes (502) where the nodes (502) are grouped into columns, however, the grouping need not be as shown in FIG. 5. The edges (504) connect the nodes (502). Edges (504) may connect, or not connect, to any node(s) (502) regardless of which layer (505) the node(s) (502) is in. That is, the nodes (502) may be sparsely and residually connected. A neural network (500) will have at least two layers (505), where the first layer (508) is considered the “input layer” and the last layer (514) is the “output layer.” Any intermediate layer (510, 512) is usually described as a “hidden layer.” A neural network (500) may have zero or more hidden layers (510, 512) and a neural network (500) with at least one hidden layer (510, 512) may be described as a “deep” neural network or as a “deep learning method.” In general, a neural network (500) may have more than one node (502) in the output layer (514). In this case the neural network (500) may be referred to as a “multi-target” or “multi-output” network.

Nodes (502) and edges (504) carry additional associations. Namely, every edge is associated with a numerical value. The edge numerical values, or even the edges (504) themselves, are often referred to as “weights” or “parameters.” While training a neural network (500), numerical values are assigned to each edge (504). Additionally, every node (502) is associated with a numerical variable and an activation function. Activation functions are not limited to any functional class, but traditionally follow the form

$$A = f ( {\sum }_{i ∈ ( incoming )} [ {( node value )}_{i} {( edge value )}_{i} ] ) ,$$

where i is an index that spans the set of “incoming” nodes (502) and edges (504) and f is a user-defined function. Incoming nodes (502) are those that, when viewed as a graph (as in FIG. 5), have directed arrows that point to the node (502) where the numerical value is being computed. Some functions for ƒ may include the linear function ƒ(x)=x, sigmoid function

$$f ( x ) = \frac{1}{1 + {e}^{- x}} ,$$

and rectified linear unit function ƒ(x)=max(0, x), however, many additional functions are commonly employed. Every node (502) in a neural network (500) may have a different associated activation function. Often, as a shorthand, activation functions are described by the function ƒ by which it is composed. That is, an activation function composed of a linear function ƒ may simply be referred to as a linear activation function without undue ambiguity.

When the neural network (500) receives an input, the input is propagated through the network according to the activation functions and incoming node (502) values and edge (504) values to compute a value for each node (502). That is, the numerical value for each node (502) may change for each received input. Occasionally, nodes (502) are assigned fixed numerical values, such as the value of 1, that are not affected by the input or altered according to edge (504) values and activation functions. Fixed nodes (502) are often referred to as “biases” or “bias nodes” (506), displayed in FIG. 5 with a dashed circle.

In some implementations, the neural network (500) may contain specialized layers (505), such as a normalization layer, or additional connection procedures, like concatenation. One skilled in the art will appreciate that these alterations do not exceed the scope of this disclosure.

As noted, the training procedure for the neural network (500) comprises assigning values to the edges (504). To begin training the edges (504) are assigned initial values. These values may be assigned randomly, assigned according to a prescribed distribution, assigned manually, or by some other assignment mechanism. Once edge (504) values have been initialized, the neural network (500) may act as a function, such that it may receive inputs and produce an output. As such, at least one input is propagated through the neural network (500) to produce an output. Training data is provided to the neural network (500). Generally, training data consists of pairs of inputs and associated targets. The targets represent the “ground truth,” or the otherwise desired output, upon processing the inputs. During training, the neural network (500) processes at least one input from the training data and produces at least one output. Each neural network (500) output is compared to its associated input data target. The comparison of the neural network (500) output to the target is typically performed by a so-called “loss function;” although other names for this comparison function such as “error function,” “misfit function,” and “cost function” are commonly employed. Many types of loss functions are available, such as the mean-squared-error function, however, the general characteristic of a loss function is that the loss function provides a numerical evaluation of the similarity between the neural network (500) output and the associated target. The loss function may also be constructed to impose additional constraints on the values assumed by the edges (504), for example, by adding a penalty term, which may be physics-based, or a regularization term (not be confused with regularization of seismic data). Generally, the goal of a training procedure is to alter the edge (504) values to promote similarity between the neural network (500) output and associated target over the training data. Thus, the loss function is used to guide changes made to the edge (504) values, typically through a process called “backpropagation.”

While a full review of the backpropagation process exceeds the scope of this disclosure, a brief summary is provided. Backpropagation consists of computing the gradient of the loss function over the edge (504) values. The gradient indicates the direction of change in the edge (504) values that results in the greatest change to the loss function. Because the gradient is local to the current edge (504) values, the edge (504) values are typically updated by a “step” in the direction indicated by the gradient. The step size is often referred to as the “learning rate” and need not remain fixed during the training process. Additionally, the step size and direction may be informed by previously seen edge (504) values or previously computed gradients. Such methods for determining the step direction are usually referred to as “momentum” based methods.

Once the edge (504) values have been updated, or altered from their initial values, through a backpropagation step, the neural network (500) will likely produce different outputs. Thus, the procedure of propagating at least one input through the neural network (500), comparing the neural network (500) output with the associated target with a loss function, computing the gradient of the loss function with respect to the edge (504) values, and updating the edge (504) values with a step guided by the gradient, is repeated until a termination criterion is reached. Common termination criteria are: reaching a fixed number of edge (504) updates, otherwise known as an iteration counter; a diminishing learning rate; noting no appreciable change in the loss function between iterations; reaching a specified performance metric as evaluated on the data or a separate hold-out data set. Once the termination criterion is satisfied, and the edge (504) values are no longer intended to be altered, the neural network (500) is said to be “trained.”

According to one or more embodiments, the second machine learned model (320) is a pre-trained NLP model, such as a BERT (Bidirectional Encoder Representations from Transformers) model trained on natural language inference (NLI) datasets, used for zero-shot classification. Further details of training machine-learned models are provided below in relation to FIG. 6.

It is noted that many variations of a random forest classifier and a zero-shot classifier exist. Therefore, one with ordinary skill in the art will recognize that any variation of the random forest classifier and a zero-shot classifier (or any other machine-learned model) may be employed for the first machine-learned (318) model and the second machine leaned model (320) without departing from the scope of this disclosure. Further, it is emphasized that the above discussions of a random forest classifier and a zero-shot classifier are basic summaries and should not be considered limiting.

FIG. 6 depicts a flowchart for training one or more machine-learned models, such as the first machine-learned model (318) and/or the second machine-learned model (320) in accordance with one or more embodiments. In one or more embodiments, the process flowchart is performed using one or more components as described in FIGS. 1-5. While the various blocks in FIG. 6 are presented and described sequentially, one of ordinary skill in the art will appreciate that some or all of the blocks may be executed in a different order, may be combined or omitted, and some or all of the blocks may be executed in parallel and/or iteratively. Furthermore, the blocks may be performed actively or passively.

Initially, in Block 602, modelling data is obtained. In accordance with one or more embodiments, the modelling data consists of one or more input-target pairs, where for a given pair, the target represents the desired output of a machine-learned model operating on the input. Thus, in the context of the instant disclosure, the modelling data for the first machine-learned model (318) can include the potential hazards dataset (312), where each input-target pair comprises an activity as the input and a hazard as the target. In the case of the second machine-learned model, the training of the NLP model, such as a BERT, may have comprised a large number of text sentences as input and their associated labels as the target.

In Block 604, the modelling data is split into a training set, validation set, and test set. In one or more embodiments, the validation and the test set are the same such that the modelling data is effectively split into a training set and a validation/test set. In an embodiment, the training set and the validation set for the first machine-learned model (318) comprise a subset of the potential hazards data set (312), and the training set and the validation set for the second machine-learned model (320) comprise a subset of the sentences and their corresponding labels.

In Block 606, a set of machine-learned models comprising the first machine learned model (318) and the second machine-learned model (320) is selected, including a machine-learned model type (e.g., a random forest classifier, zero-shot classifier) and an architecture (e.g., number of decision trees, aggregation functions, number of layers etc.) of each machine-learned model in the set of machine learning models. In accordance with one or more embodiments, multiple machine-learned model types and architectures are evaluated to discover the model with the best performance. In accordance with one or more embodiments, the selection of the machine-learned model type and architecture is performed by cycling through a set of user-defined models and associated architectures. In other embodiments, the machine-learned model type and architecture are selected based on the performance of previous models, for example, using a Bayesian-based search. In Block 608, the set of machine learning models is trained using the training set.

Each machine-learned model (318, 320) of the set of machine learning models processes an input from an input-target pair of the training data and produces an output. The output is compared to the target. During training, each machine-learned model (318, 320) is adjusted such that the output of the machine-learned model (318, 320) is similar to the target.

In an embodiment, the second machine-learned model is trained independently of the first machine-learned model.

Once each machine-learned model of the set of machine learning models is trained, in Block 610, the input-target pairs of the validation set are processed by the trained set of machine learning models (318, 320). The output of the set of machine learning models is compared to the target data in the validations set. Thus, the performance of the trained set of machine learning models can be evaluated.

Block 612 represents a decision. If the trained set of machine learning models is found to have suitable performance as evaluated on the validation set, where the criterion for suitable performance is defined by a user, then the trained set of machine learning models is accepted for use on future activity data. When the set of machine learning models is used on new future activity data, the set of machine learning models is said to be used in production. In Block 616, the trained machine-learned models (318, 320) are used in production. However, before the machine-learned models (318, 320) are used in production a final indication of their performance can be acquired by estimating the generalization error of each trained machine-learned model (318, 320), as shown in Block 614. The generalization error is estimated by evaluating the performance of the trained set of machine learning models, after a suitable model has been found, on the test sets. One with ordinary skill in the art will recognize that the training procedure depicted in FIG. 6 is general and that many adaptions can be made without departing from the scope of the present disclosure. For example, common training techniques, such as early stopping, adaptive or scheduled learning rates, and cross-validation may be used during training without departing from the scope of this disclosure.

Once the first machine-learned model (318) is in production it can be used to predict a predicted hazard (208) hazard for a future activity (202) scheduled to take place in the future.

Once the second machine-learned model (320) is in production, it can be used to generate a dataset of hazards against impact areas. According to one or more embodiments, a first natural language processing (NLP) algorithm (322) processes the database generated by the second machine-learned model (320) to output an impact area for the predicted hazard (208) predicted by the first machine-learned model (318). According to an embodiment, the first NLP algorithm (322) is a semantic search that receives the predicted hazard (208) predicted by the first machine-learned model (318), and searches the database to find the impact area (210) associated with the predicted hazard (208). According to one or more embodiments, a second NLP algorithm (324) in the hazard prediction engine (204) is used to determine the risk assessment score (212) using the incident hazards dataset (314). According to one or more embodiments, the second NLP algorithm (324) is a semantic search that receives the predicted hazard (208) predicted by the first machine-learned model (318), and searches the incident hazards dataset (314) to determine a frequency of occurrence of the predicted hazard (208) in the incident hazards dataset (314). The frequency of occurrence of the predicted hazard (208) may be a number of times the predicted hazard (208) is entered in the incident hazards dataset (314). The determined frequency of occurrence is used to calculate the severity (216) and the probability of occurrence (218).

According to one or more embodiments, the severity (216) may be provided on a scale, for example a scale of 1 to 5, with 5 indicating a high severity, and a 1 indicating a low severity. As an example only, if the predicted hazard (208) is a fatality, then a single occurrence of the fatality in the incident hazards dataset (314) may cause a severity (216) of 5. As an example only, if the predicted hazard (208) is lost time due to injury, then a single occurrence of lost time due to injury in the incident hazards dataset (314) may cause a severity (216) of 4. As an example only, if the predicted hazard (208) is restricted duty injury, then a single occurrence of restricted duty injury in the incident hazards dataset (314) may cause a severity (216) of 3. As an example only, if the predicted hazard (208) is medical treatment for injury/illness, then a single occurrence of medical treatment for injury/illness in the incident hazards dataset (314) may cause a severity (216) of 2. A single occurrence of all other types of predicted hazard (208), may cause a severity (216) of 1, since they result in first aid injuries.

According to one or more embodiments, the probability of occurrence (218) is calculated as the frequency of occurrence of the predicted hazard (208) divided by the total number of occurrences of total hazards. The probability of occurrence (218) may be represented as a percentage, such as (the frequency of occurrence of the predicted hazard (208) divided by the total number of occurrences of total hazards)×100.

According to one or more embodiments, the probability of occurrence (218) may be provided on a scale, for example 1 to 5, where 5 indicates a high probability of occurrence and 1 indicates a low probability of occurrence. As an example only, the probability of occurrence may first be represented as a percentage as detailed above, and then converted to a scale. As an example only, if the probability of occurrence (218) is between 0-20%, then a score of 1 may be provided. As an example only, if the probability of occurrence (218) is between 20-40%, then a score of 2 may be provided. As an example only, if the probability of occurrence (218) is between 40-60%, then a score of 3 may be provided. As an example only, if the probability of occurrence (218) is between 60-80%, then a score of 4 may be provided. As an example only, if the probability of occurrence (218) is between 80-100%, then a score of 2 may be provided.

The above examples of the calculation of the severity (216) and the probability of occurrence (218) are presented as examples only, and should not be considered limiting.

According to one or more embodiments, once the severity (216) and the probability of occurrence (218), they may be saved in a risk assessment data set as follows:
a. Hazard A
   i. Likelihood (Numerical, between 0-5)
   ii. Severity (Numerical, between 0-5)
b. Hazard B
   i. Likelihood (Numerical, between 0-5)
   ii. Severity (Numerical, between 0-5)
c. Hazard C
   i. Likelihood (Numerical, between 0-5)
   ii. Severity (Numerical, between 0-5)

According to one or more embodiments, the risk assessment score (212) is returned from the second NLP algorithm 324 as the product of the severity (216) by the probability of occurrence (218).

According to one or more embodiments, a user may input an additional control measure. For example, the user may input personal protective equipment (PPE) measures that are being used for the project of which the planned future activity is part. Using the additional control measure, the risk assessment score (212) may be modified to generate a residual risk assessment score. The residual risk assessment score may indicate a reduced risk of the predicted hazard, given that certain control measures are in place. The residual risk assessment score may comprise a residual severity and or a residual probability of occurrence. According to an embodiment, the hazard prediction data (206) comprises the residual risk assessment score.

According to one or more embodiments, a third NLP algorithm (326) in the hazard prediction engine (204) is used to determine the mitigation action (214) using the mitigation action dataset (316). According to one or more embodiments, the third NLP algorithm (326) is a semantic search that receives the predicted hazard (208) predicted by the first machine-learned model (318), and searches the mitigation action dataset (316) to determine a mitigation action (214) associated with the predicted hazard (208). The mitigation action (214) may comprise a single or multipole mitigation actions.

According to one or more embodiments, the first NLP algorithm (322), the second NLP algorithm (324) and the third NLP algorithm (326) may be combined in a single NLP algorithm.

The hazard prediction data (206) may then be displayed to a user on a computing device or provided to the construction planning system (160) to reduce risk associated with the project for which the future activity (202) is planned.

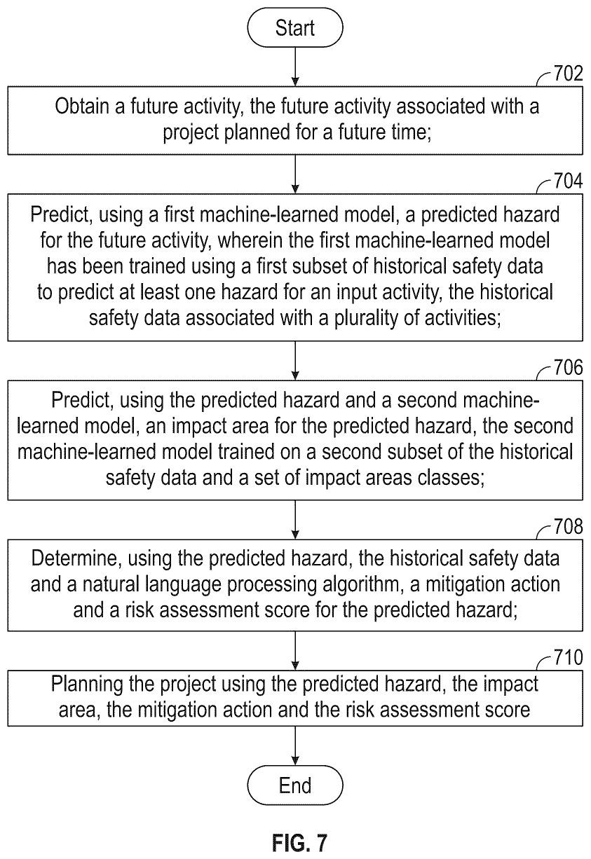

FIG. 7 depicts a flowchart outlining the method according to one or more embodiments of the present disclosure. In Block 702, a future activity is obtained. The future activity is associated with a project planned for a future time. In other words, the future activity is scheduled to take place in the future.

In Block 704, using a first machine-learned model, a predicted hazard for the future activity is predicted. The first machine-learned model has been trained using a first subset of historical safety data to predict at least one hazard for an input activity. The historical safety data is associated with a plurality of activities.

In Block 706, using the predicted hazard and a second machine-learned model, an impact area for the predicted hazard is determined. The second machine-learned model has been trained on a second subset of the historical safety data and a set of impact areas classes.

In Block 708, using the predicted hazard, the historical safety data and a natural language processing algorithm, a mitigation action and a risk assessment score for the predicted hazard are determined.

In Block 710, the project is planned using the predicted hazard, the impact area, the mitigation action and the risk assessment score.

Hazards, such they occur, can severely impact projects such as construction activities, resulting in reduced personnel, increased costs, project delays or the cancellation of projects. The above method contributes to the planning phase of projects by predicting hazards and their risk assessment score along with required mitigation actions, which can enable a project to be more efficiently planned. By taking into account the predicted hazards, risk assessment score and mitigation action, a project can be adapted to account for the personnel needed, their readiness, equipment, additional work required to reduce risk, or rescheduling planned construction activities. Such a method and system can assist project managers and safety officers in better planning for project activities and leads to increased efficiency and safety in planning projects.

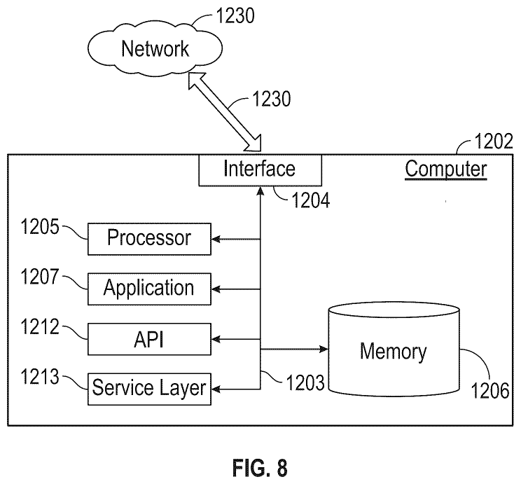

FIG. 8 further depicts a block diagram of a computer (802) system used to provide computational functionalities associated with the methods, functions, processes, flows, and procedures as described in this disclosure, according to one or more embodiments. The illustrated computer (802) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (802) may include a computer that includes an input device, such as a keypad, keyboard, touch screen, or other device that can accept user information, and an output device that conveys information associated with the operation of the computer (802), including digital data, visual, or audio information (or a combination of information), or a GUI.

The computer (802) can serve in a role as a client, network component, a server, a database or other persistency, or any other component (or a combination of roles) of a computer system for performing the subject matter described in the instant disclosure. In some implementations, one or more components of the computer (802) may be configured to operate within environments, including cloud-computing-based, local, global, or other environment (or a combination of environments).

At a high level, the computer (802) is an electronic computing device operable to receive, transmit, process, store, or manage data and information associated with the described subject matter. According to some implementations, the computer (802) may also include or be communicably coupled with an application server, e-mail server, web server, caching server, streaming data server, business intelligence (BI) server, or other server (or a combination of servers).

The computer (802) can receive requests over network (830) from a client application (for example, executing on another computer (802) and responding to the received requests by processing the said requests in an appropriate software application. In addition, requests may also be sent to the computer (802) from internal users (for example, from a command console or by other appropriate access method), external or third-parties, other automated applications, as well as any other appropriate entities, individuals, systems, or computers.

Each of the components of the computer (802) can communicate using a system bus (803). In some implementations, any or all of the components of the computer (802), both hardware or software (or a combination of hardware and software), may interface with each other or the interface (804) (or a combination of both) over the system bus (803) using an application programming interface (API) (812) or a service layer (813) (or a combination of the API (812) and service layer (813). The API (812) may include specifications for routines, data structures, and object classes. The API (812) may be either computer-language independent or dependent and refer to a complete interface, a single function, or even a set of APIs. The service layer (813) provides software services to the computer (802) or other components (whether or not illustrated) that are communicably coupled to the computer (802). The functionality of the computer (802) may be accessible for all service consumers using this service layer. Software services, such as those provided by the service layer (813), provide reusable, defined business functionalities through a defined interface. For example, the interface may be software written in JAVA, C++, or other suitable language providing data in extensible markup language (XML) format or another suitable format. While illustrated as an integrated component of the computer (802), alternative implementations may illustrate the API (812) or the service layer (813) as stand-alone components in relation to other components of the computer (802) or other components (whether or not illustrated) that are communicably coupled to the computer (802). Moreover, any or all parts of the API (812) or the service layer (813) may be implemented as child or sub-modules of another software module, enterprise application, or hardware module without departing from the scope of this disclosure.

The computer (802) includes an interface (804). Although illustrated as a single interface (804) in FIG. 8, two or more interfaces (804) may be used according to particular needs, desires, or particular implementations of the computer (802). The interface (804) is used by the computer (802) for communicating with other systems in a distributed environment that are connected to the network (830). Generally, the interface (804) includes logic encoded in software or hardware (or a combination of software and hardware) and operable to communicate with the network (830). More specifically, the interface (804) may include software supporting one or more communication protocols associated with communications such that the network (830) or interface's hardware is operable to communicate physical signals within and outside of the illustrated computer (802).

The computer (802) includes at least one computer processor (805). Although illustrated as a single computer processor (805) in FIG. 8, two or more processors may be used according to particular needs, desires, or particular implementations of the computer (802). Generally, the computer processor (805) executes instructions and manipulates data to perform the operations of the computer (802) and any algorithms, methods, functions, processes, flows, and procedures as described in the instant disclosure.

The computer (802) also includes a memory (806) that holds data for the computer (802) or other components (or a combination of both) that can be connected to the network (830). The memory may be a non-transitory computer readable medium (also referred to as a non-transitory machine-readable medium). For example, memory (806) can be a database storing data consistent with this disclosure. Although illustrated as a single memory (806) in FIG. 8, two or more memories may be used according to particular needs, desires, or particular implementations of the computer (802) and the described functionality. While memory (806) is illustrated as an integral component of the computer (802), in alternative implementations, memory (806) can be external to the computer (802).

The application (807) is an algorithmic software engine providing functionality according to particular needs, desires, or particular implementations of the computer (802), particularly with respect to functionality described in this disclosure. For example, application (807) can serve as one or more components, modules, applications, etc. Further, although illustrated as a single application (807), the application (807) may be implemented as multiple applications (807) on the computer (802). In addition, although illustrated as integral to the computer (802), in alternative implementations, the application (807) can be external to the computer (802).

There may be any number of computers (802) associated with, or external to, a computer system containing computer (802), wherein each computer (802) communicates over network (830). Further, the term “client,” “user,” and other appropriate terminology may be used interchangeably as appropriate without departing from the scope of this disclosure. Moreover, this disclosure contemplates that many users may use one computer (802), or that one user may use multiple computers (802).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method, comprising:
obtaining a future activity, the future activity associated with a project planned for a future time;
predicting, using a first machine-learned model, a predicted hazard for the future activity, wherein the first machine-learned model has been trained using a first subset of historical safety data to predict at least one hazard for an input activity, the historical safety data associated with a plurality of activities;
predicting, using the predicted hazard and a second machine-learned model, an impact area for with the predicted hazard, the second machine-learned model trained on a second subset of the historical safety data and a set of impact areas classes;
determining, using the predicted hazard, the historical safety data and a natural language processing algorithm, a mitigation action for the predicted hazard and a risk assessment score for the predicted hazard; and
planning the project using the predicted hazard, the impact area, the mitigation action and the risk assessment score.

2. The method of claim 1, wherein the project comprises constructing one of a well system, a pipeline network, and a processing plant.

3. The method of claim 1, wherein the historical safety data comprises historical safety analysis documents, historical incident reports, and historical risk registers.

4. The method of claim 1, wherein the first machine-learned model is a random forest classifier.

5. The method of claim 1, wherein the second machine-learned model is a zero-shot classification model configured to generate a dataset of impact areas against activities from the historical safety data, wherein predicting the impact area comprises:
applying a semantic search on the dataset to determine the impact area.

6. The method of claim 1, wherein the risk assessment score indicates a probability of the predicted hazard occurring or a severity of the predicted hazard should it occur.

7. The method of claim 1, wherein the historical safety data comprises a mitigation action dataset that maps hazards to mitigation actions, wherein the mitigation dataset has been generated from a plurality of historical risk registers, wherein determining the mitigation action comprises:
applying a semantic search on the mitigation action dataset to determine the mitigation action using the predicted hazard.

8. The method of claim 1, wherein the historical safety data comprises an incident hazards dataset that maps each of a plurality of historical activities with a corresponding historical hazard that was caused by the respective historical activity, wherein the incident hazards dataset has been generated from a plurality of historical incident reports, wherein determining the risk assessment score comprises:
applying a semantic search on the incident hazards dataset to determine a frequency of the predicted hazard in the incident hazards dataset; and
determining the risk assessment score using the frequency.

9. The method of claim 8, where in the incident hazards dataset has been generated using an extractive question and answering pipeline applied to the incident hazards dataset.

10. The method of claim 1, further comprising:
receiving details of a control measure;
generating a residual risk assessment score using the details of the control measure and the risk assessment score; and
planning the project using the residual risk assessment score.

11. A system, comprising:
a first machine-learned model;
a second machine-learned model; and
a computer configured to:
obtain a future activity, the future activity associated with a project planned in for a future time;
predict, using the first machine-learned model, a predicted hazard for the future activity, wherein the first machine-learned model has been trained using a first subset of historical safety data to predict at least one hazard for an input activity, the historical safety data associated with a plurality of activities;
predict, using the predicted hazard and the second machine-learned model, an impact area for the predicted hazard, the second machine-learned model trained on a second subset of the historical safety data and a set of impact areas classes;
determine, using the predicted hazard, the historical safety data and a natural language processing algorithm, a mitigation action and a risk assessment score for the predicted hazard; and
plan the project using the predicted hazard, the impact area, the mitigation action and the risk assessment score.

12. The system of claim 11, wherein the project comprises constructing one of a well system, a pipeline network, and a processing plant.

13. The system of claim 11, wherein the historical safety data comprises historical safety analysis documents, historical incident reports, and historical risk registers.

14. The system of claim 11, wherein the first machine-learned model is a random forest classifier.

15. The system of claim 11, wherein the second machine-learned model is a zero-shot classification model configured to generate a dataset of impact areas against activities from the historical safety data, the computer further configured to:
apply a semantic search on the dataset to determine the impact area.

16. The system of claim 11, wherein the risk assessment score indicates a probability of the predicted hazard occurring or a severity of the predicted hazard should it occur

17. The system of claim 11, wherein the historical safety data comprises a mitigation action dataset that maps hazards to mitigation actions, wherein the mitigation dataset has been generated from a plurality of historical risk registers, the computer further configured to:
apply a semantic search on the mitigation action dataset to determine the mitigation action using the predicted hazard.

18. The system of claim 11, wherein the historical safety data comprises an incident hazards dataset that maps each of a plurality of historical activities with a corresponding historical hazard that was caused by the respective historical activity, wherein the incident hazards dataset has been generated from a plurality of historical incident reports, the computer further configured to:
apply a semantic search on the incident hazards dataset to determine a frequency of the predicted hazard in the incident hazards dataset; and
determine the risk assessment score using the frequency.

19. The system of claim 18, where in the incident hazards dataset has been generated using an extractive question and answering pipeline applied to the incident hazards dataset.

20. A non-transitory machine-readable medium comprising a plurality of machine-readable instructions executed by one or more processors, the plurality of machine-readable instructions causing the one or more processors to perform a method comprising:
obtaining a future activity, the future activity associated with a project planned for a future time;
predicting, using a first machine-learned model, a predicted hazard for the future activity, wherein the first machine-learned model has been trained using a first subset of historical safety data to predict at least one hazard for an input activity, the historical safety data associated with a plurality of activities;
predicting, using the predicted hazard and a second machine-learned model, an impact area associated with the future activity, the second machine-learned model trained on a second subset of the historical safety data and a set of impact areas classes;
determining, using the predicted hazard, the historical safety data and a natural language processing algorithm, a mitigation action and a risk assessment score; and
planning the project using the predicted hazard, the impact area, the mitigation action and the risk assessment score.
